(19) United States
(12) Patent Application Publication
(10) Pub. No.: US 2025/0098719 A1
(43) Pub. Date: Mar. 27, 2025

(54) SKIPJACK TUNA EXTRACT HAVING INCREASED FLAVOR AND UMAMI, AND METHOD FOR PRODUCING SAME

(71) Applicant: CJ CHEILJEDANG CORPORATION, Seoul (KR)

(72) Inventors: Sun Ok KIM, Seoul (KR); Chul Jin KIM, Seoul (KR)

(73) Assignee: CJ CHEILJEDANG CORPORATION, Seoul (KR)

(21) Appl. No.: 18/724,589

(22) PCT Filed: Dec. 28, 2022
(86) PCT No.: PCT/KR2022/021464

§ 371 Date: Jun. 26, 2024

(30) Foreign Application Priority Data
Dec. 29, 2021 (KR) 10-2021-0191601

(51) Int. Cl. A23L 27/10; A23L 23/00

(52) U.S. Cl. CPC A23L 27/10; A23L 23/00

(57) ABSTRACT

The present disclosure relates to a method for preparing a bonito extract by extracting katsuobushi under low temperature and reduced pressure; a bonito extract which is prepared by extraction under low temperature and reduced pressure, and has reduced off-flavor and bitter taste and increased flavor and umami taste; a method for preparing a tuna fish sauce, comprising a processing step of mixing and sterilizing the bonito extract and seasoning ingredients; and a tuna fish sauce.

### TECHNICAL FIELD

The present disclosure relates to a method for preparing a bonito (skipjack tuna) extract by extracting katsuobushi under low temperature and reduced pressure; a bonito extract which is prepared by extraction under low temperature and reduced pressure, and has reduced off-flavor and bitter taste and increased flavor and umami taste; a method for preparing a tuna fish sauce, including a processing step of mixing and sterilizing the bonito extract and seasoning ingredients; and a tuna fish sauce.

### BACKGROUND ART

The present disclosure relates to a bonito extract with increased flavor and umami taste and a preparation method thereof, and specifically relates to a bonito extract, which is prepared by extracting bonito flakes under low temperature and reduced pressure, and thus has reduced off-flavor and bitter taste and increased flavor and umami taste.

The hot water extraction method employed to produce existing katsuobushi extracts is carried out under conditions of extraction at high temperature for a long time in order to maximize the extraction of the flavor components of katsuobushi. Thus, there was a problem that not only the main flavor of katsuobushi is extracted, but also the bitter taste, fishy odor, off-flavor, and stale taste are extracted along therewith (Korean Patent No. 10-1788616 B).

Additionally, when preparing seasoning ingredients using bonito extracts prepared by hot water, the use of chemical additives (MSG, IMP, or GMP, etc.) to mask the bitter taste and off-flavor, etc., was inevitable, thus the production of seasoning materials with a strong umami taste was needed, which was a problem.

Accordingly, in order to solve the above-mentioned technical difficulties, the present inventors prepared the bonito extract using a different extraction method, and as a result confirmed that a bonito extract with reduced off-flavor and bitter taste and increased flavor and umami taste can be prepared, and thus completed the present disclosure.

### DISCLOSURE

### Technical Problem

The present disclosure relates to a bonito extract with increased flavor and umami taste and a preparation method thereof.

### Technical Solution

It is one object of the present disclosure to provide a method for preparing a bonito extract by extracting katsuobushi under low temperature and reduced pressure.

It is another object of the present disclosure to provide a bonito extract, which is prepared by extraction under low temperature and reduced pressure, and has reduced off-flavor and bitter taste and increased flavor and umami taste.

It is still another object of the present disclosure to provide a method for preparing a tuna fish sauce with increased flavor and umami taste, including: a processing step of mixing and sterilizing a bonito extract extracted under low temperature and reduced pressure; and seasoning ingredients.

It is yet another object of the present disclosure to provide a tuna fish sauce with increased flavor and umami taste, including a bonito extract extracted under low temperature and reduced pressure.

### Advantageous Effects

The bonito extract prepared by extraction under low temperature and reduced pressure of the present disclosure has excellent sensory characteristics with reduced off-flavor and bitter taste and increased flavor and umami taste. Additionally, the bitter taste, fishy odor, and off-flavor can be reduced compared to the existing hot water extraction method, and thus, there is an advantage in that a sauce composition can be prepared without using chemical additives to mask the above characteristics.

### BRIEF DESCRIPTION OF DRAWINGS

FIG. 1 shows the preparation process of a bonito extract including katsuobushi and dried kelp.

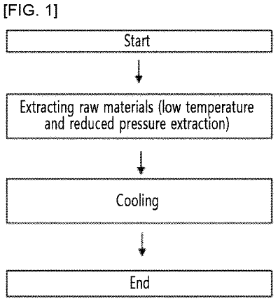

FIG. 2 shows the preparation process of tuna fish sauce.

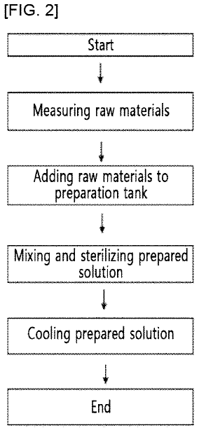

### DETAILED DESCRIPTION OF PREFERRED EMBODIMENTS

The present disclosure will be described in detail as follows. Meanwhile, each description and embodiment disclosed herein can be applied to other descriptions and embodiments, respectively. That is, all combinations of various elements disclosed herein fall within the scope of the present disclosure. Further, the scope of the present disclosure is not limited by the specific description described below.

Additionally, a number of papers and patent documents have been cited throughout the present specification, and their citations are indicated. The content of the cited papers and patent documents is incorporated herein by reference in their entirety and the level of technical field to which the present disclosure belongs and the contents of the present disclosure will be described more clearly.

One aspect of the present disclosure provides a method for preparing a bonito extract by extracting katsuobushi under low temperature and reduced pressure.

As used herein, the term “bonito extract” may refer to katsuobushi, i.e., a processed bonito product, and may refer to an extract extracted from slices or flakes prepared by processing bonito.

The katsuobushi may refer to a food ingredient prepared by smoking and drying bonito, or steaming bonito and then smoking, fermenting, and drying the same, but is not limited thereto.

The katsuobushi may include any commercially available katsuobushi without limitation, and there is no particular limitation on the preparation method.

As used herein, the term “extract” refers to a resulting product, such as a liquid component which is obtained by immersing a desired material in various solvents followed by extracting for a predetermined period of time at room temperature, at low temperature, or in a heated state; a solid component which is obtained by removing the solvent from the liquid component; etc. Moreover, the extract may be comprehensively interpreted to include all of a diluted solution of the resulting products, a concentrated solution thereof, a crude product thereof, a purified product thereof, etc., in addition to the above resulting products.

In the present disclosure, the extract means the bonito extract. The bonito extract can be obtained by extraction with water or various organic solvents, etc. In particular, the type of solvent used is not particularly limited as long as the bonito extract can be obtained, but specifically, it may be water, a polar solvent, or a non-polar solvent, and more specifically, it may be water, a lower alcohol with 1 to 6 carbon atoms (methanol, ethanol, propanol, or butanol, etc.), or a mixed solvent thereof, and preferably, water, but is not limited thereto.

Additionally, the method for obtaining the extract is not particularly limited as long as the bonito extract can be obtained, and the method may specifically include a cold immersion extraction method of immersing the katsuobushi in the solvent and extracting at room temperature, a heating extraction method of extracting the katsuobushi by heating to 40 to 100° C., an ultrasonic extraction method by applying ultrasonic waves, a reflux extraction method using a reflux condenser, etc.

In one embodiment of the present disclosure, the bonito extract may be prepared by an extraction method under low temperature and reduced pressure.

In one embodiment of the present disclosure, the temperature condition for the low temperature reduced pressure extraction may be a temperature condition of 45 to 55° C., the reduced pressure condition may be a pressure condition of 150 to 250 mbar, more specifically 200 mbar, and the time condition may be 35 to 50 minutes.

In one embodiment of the present disclosure, when using the low temperature and reduced pressure extraction method compared to the hot water extraction method, it was confirmed that the off-flavor-related components, such as 2-butanone, 2-ethylpyridine, 2,6-dimethylpyrazine, and eugenol were reduced, and the bitter taste-related amino acid components, such as valine, isoleucine, and leucine were also reduced, and thus, the off-flavor and bitter taste of the bonito extract were reduced by the low-temperature and reduced-pressure extraction, and excellent flavor, taste, and umami taste were confirmed. Accordingly, it was confirmed that the low temperature and reduced pressure extraction method is suitable for the preparation of bonito extract.

In addition, in another embodiment of the present disclosure, the optimal temperature and time conditions were confirmed by comparing the flavor components and sensory characteristics of the bonito extract for each temperature and time under reduced pressure conditions.

Specifically, under the reduced pressure conditions (150 to 250 mbar), it was confirmed that the umami taste of the bonito extract was increased while maintaining the flavor components at a temperature of 45 to 55° C., and the sensory evaluation results also showed excellent sensory characteristics.

Additionally, when the bonito extract was extracted under reduced pressure and low temperature conditions for a time of 35 to 50 minutes, the umami taste components of the bonito extract were increased, and the sensory evaluation results also showed that the flavor, taste, and umami taste were increased, and the bitter taste was reduced, confirming that the above time conditions were optimal.

In one embodiment of the present disclosure, the bonito extract may include concentrates, filtrates, fractions, dried products, pulverized products, etc., which are prepared by conventional additional processes such as concentration, filtration, fractionation, drying, pulverization, etc. after extraction. In particular, the term ‘concentrate’ may refer to a substance in which the concentration of the main solid component is increased by removing solvents, etc. from a chemical substance, the term ‘filtrate’ may refer to a substance obtained by separating a mixture of liquid and solid using a difference in particle size, the term ‘fraction’ is a result product obtained by a fractionation method of separating a specific component or specific group from a mixture containing various components, the term ‘dried product’ is a result product obtained by a method of removing water from a substance containing a small amount of water, and the term ‘pulverized product’ may refer to a result product obtained by applying force to solid particles to break them into small pieces or cut them into small particles. In particular, the concentrate, filtrate, fraction, dried product, pulverized product, etc. can be obtained by a conventional method capable of obtaining the corresponding result products, and are not particularly limited thereto.

Another aspect of the present disclosure provides a bonito extract, which is prepared by extraction under low temperature and reduced pressure, and has reduced off-flavor and bitter taste and increased flavor and umami taste.

The bonito extract of the present disclosure may include phenol or 2,6-dimethoxy, which are flavor components, but is not limited thereto.

Among the flavor components, the phenol may be contained in an amount of 10000 to 20000 ppm/L, 15000 to 20000 ppm/L, 17000 to 19500 ppm/L, and 18000 to 19000 ppm/L, but is not limited thereto.

Among the flavor components, the 2,6-dimethoxy may be contained in an amount of 1100 to 2000 ppm/L, 1200 to 18000 ppm/L, and 1300 to 16000 ppm/L, but is not limited thereto.

The bonito extract of the present disclosure may include aspartic acid or glutamic acid, which are umami-tasting amino acids, but is not limited thereto.

The aspartic acid, an umami-tasting amino acid, may be contained in an amount of 24 to 40 mg/L, 28 to 35 mg/L, and 30 to 34 mg/L, but is not limited thereto.

The glutamic acid, an umami-tasting amino acid, may be contained in an amount of 33 to 50 mg/L, 35 to 45 mg/L, and 39 to 43 mg/L, but is not limited thereto.

The bonito extract of the present disclosure may be one in which off-flavor compounds and bitter-tasting amino acids are reduced.

The off-flavor compound may be any one or more selected from 2-butanone, 2-ethylpyridine, 2,6-dimethylpyrazine, and eugenol, but is not limited thereto.

The bitter-tasting amino acid may be any one or more selected from valine, isoleucine, or leucine, but is not limited thereto.

Additionally, the tuna fish sauce including the bonito extract, which is prepared by the low temperature and reduced pressure extraction of the present disclosure, may be one in which the flavor components are maintained, and the flavor component may be phenol or 2,6-dimethoxy, but is not limited thereto.

Still another aspect of the present disclosure provides a method for preparing a tuna fish sauce with increased flavor and umami taste, including: a processing step of mixing and sterilizing the bonito extract prepared by the low temperature and reduced pressure extraction, and seasoning ingredients.

The term “tuna fish sauce” relates to a sauce composition including the bonito extract, and the processing step of mixing and sterilization may include any mixing or sterilizing method commonly used in the art, and is not particularly limited, as long as tuna fish sauce including the bonito extract can be prepared by the above preparation method.

Yet another aspect of the present disclosure provides a tuna fish sauce with increased flavor and umami taste, including: the bonito extract extracted under low temperature and reduced pressure; and any one or more selected from seasoning ingredients, refined salt, and oligosaccharides.

In one embodiment of the present disclosure, the tuna fish sauce may be a tuna fish sauce with increased flavor and umami taste, including: the bonito extract extracted under low temperature and reduced pressure; and any one or more selected from kelp, ginger, garlic, refined salt, and oligosaccharides.

As used herein, the term “seasoning ingredient” may include any seasoning ingredient without particular limitation as long as it belongs to the seasoning sauce using the bonito extract, except chemical additives such as MSG, IMP, or GMP, etc.

In one embodiment of the present disclosure, the seasoning ingredient may be any one selected from kelp, ginger, and garlic, and may be an extract or concentrate thereof, but is not limited thereto.

In one embodiment of the present disclosure, the seasoning ingredient may be 0.5 to 5% by weight, 1 to 3% by weight, or 1.2 to 2.6% by weight based on the total weight of the tuna fish sauce, but is not limited thereto.

In one embodiment of the present disclosure, the ratio of kelp:ginger; and garlic of the seasoning ingredients may be 0.5 to 3:0.05 to 1.5:0.05 to 1.5, but is not limited thereto.

A tuna fish sauce with excellent sensory characteristics may be prepared by including the seasoning ingredients within the above range.

The tuna fish sauce of the present disclosure may include any one or more selected from a fermented extract, an apple extract, refined salt, and oligosaccharide, but is not limited thereto.

The oligosaccharide is a linkage of saccharides such as fructose, galactose, and glucose, and it may be fructooligosaccharide or isomaltooligosaccharide, but is not limited thereto.

Additionally, the tuna fish sauce may additionally include an aged tuna liquid or a katsuo extract, but is not limited thereto.

In one embodiment of the present disclosure, the tuna fish sauce may contain 50 to 70% by weight, 55 to 65% by weight, or 57 to 63% by weight of the bonito extract, may contain 1 to 5% by weight or 2 to 3% by weight of the fermented extract (TasteNrich, TNR), may contain 0.1 to 3% by weight or 0.5 to 1.5% by weight of the apple extract, may contain 10 to 20% by weight, 15 to 19% by weight, or 17 to 18.5% by weight of the refined salt, and may contain 5 to 10% by weight or 7 to 9% by weight of isomaltooligosaccharide, based on the total weight of the tuna fish sauce, but is not limited thereto. The fermented extract may be a fermented product produced during a microbial fermentation process, and may contain one or more components selected from nucleic acids, amino acids, organic acids, and saccharides, but is not limited thereto.

Additionally, the tuna fish sauce may further contain an aged tuna liquid, a tuna cooking liquid, or a katsuo extract in an amount of 0.1 to 5% by weight or 1 to 3% by weight based on the total weight of the tuna fish sauce, but is not limited thereto A tuna fish sauce with excellent sensory characteristics may be prepared by including the seasoning ingredients within the above range.

In the present disclosure, it was confirmed by the embodiments of the present disclosure that the bonito extract prepared by extraction under low temperature and reduced pressure has excellent effects of sensory characteristics as the off-flavor-related components are reduced, the bitter-tasting amino acids are reduced, the umami-tasting amino acids are increased, and the flavor components are maintained.

Additionally, when the bonito extract prepared by the low temperature and reduced pressure extraction method is included, the bitter taste, fishy odor, and off-flavor can be reduced compared to the existing hot water extraction method, and thus, there is an advantage in that seasoning materials can be prepared without using chemical additives in order to mask the above characteristics.

Even another aspect of the present disclosure provides a food composition including the bonito extract extracted under low temperature and reduced pressure.

As used herein, the term “food” may include all foods in a conventional sense, such as meats, sausages, breads, chocolates, candies, snacks, cookies, pizzas, ramens, other noodles, gums, dairy products including ice cream, various kinds of soups, beverages, teas, drinks, alcoholic beverages, vitamin complexes, health functional foods, health foods, etc.

The food of the present disclosure may be prepared by methods commonly used in the art, and may be prepared by adding raw materials and ingredients commonly added in the art.

Additionally, the food composition may be prepared in various forms of formulations without limitation as long as it is a formulation recognized as a food.

Further another aspect of the present disclosure provides the use of bonito extract prepared by the low temperature and reduced pressure extraction method for the preparation of a food composition.

In one embodiment of the present disclosure, the food composition may be a sauce, and may be a tuna fish sauce, but is not limited thereto.

The terms used herein are as described in other aspects above.

### MODE FOR CARRYING OUT THE INVENTION

Hereinafter, the present disclosure will be described in detail by way of Examples. However, these Examples are merely preferred Examples given for illustrative purposes, and thus, the scope of the present disclosure is not intended to be limited to or by these Examples. Meanwhile, technical features which are not described herein can be sufficiently understood and easily carried out by those skilled in the art in the technical field of the present disclosure or in a similar technical field.

### Example 1. Preparation Method of Tuna Fish Sauce

Bonito extract and tuna fish sauce including the extract were prepared by the following method. As materials used in the experiment, commercially available products of katsuobushi, dried kelp, refined salt, isomaltooligosaccharide, ginger concentrate, garlic concentrate, and fermented extract (TasteNrich, TNR) were used, and the aged tuna liquid was provided by the Honeybee company to be used in the experiment.

### Example 1-1. Preparation of Bonito Extract

In order to prepare bonito extract under low temperature and reduced pressure conditions of the present disclosure, katsuobushi (5%) and dried kelp (0.5%) were extracted (30 to 50 minutes) under low temperature (60° C. or lower) and reduced pressure conditions (150 to 250 mbar) and filtered to prepare bonito extract, and the optimal extraction conditions for bonito were confirmed through Experimental Examples.

### Experimental Example 1. Confirmation of Optimal Extraction Method for Preparation of Bonito Extract

In order to confirm the optimal extraction conditions for bonito extract with reduced off-flavor and bitter taste of katsuobushi, the low temperature and reduced pressure extraction method of the present disclosure was compared with the existing hot water extraction method.

Specifically, in order to examine the optimal conditions for extracting katsuobushi and kelp in water to prepare bonito extract, a comparative experiment was set up between the reduced pressure extraction, which is a low temperature (60° C. or lower) and reduced pressure (150 to 250 mbar) condition with no evaporation, and the hot water extraction (90° C.), which is the existing commercialized condition.

Specifically, bonito extract was prepared by extraction at 50° C. for 60 minutes under reduced pressure conditions (200 mbar) and by extraction at 90° C. for 60 minutes under hot water conditions, which is the existing extraction method.

The thus-obtained extracts were filtered, and the main flavor components, taste components, and sensory preference of the extracts were analyzed. As a result, it was confirmed that the off-flavor-related components (2-butanone, 2-ethylpyridine, 2,6-dimethylpyrazine, eugenol) and bitter taste-related components (Val, lie, Leu) among the main taste components of the bonito extract extracted under low temperature and reduced pressure were reduced. Additionally, as a result of the sensory evaluation, it was confirmed that the bonito extract extracted by the low temperature and reduced pressure extraction process showed excellent effects in terms of katsuo flavor, taste, and umami taste.

TABLE 1

| | | | | | | | | Sensory | | |
|---|---|---|---|---|---|---|---|---|---|---|
| Extraction | | | | | | | | Evaluation Result | | |
| Condition | Flavor Component (Relative area) | | | | Taste Components | | | (5 points) | | |
| Main | | 2- | 2,6- | | (mg/L) | | | Katsuo | Katsuo | Umami |
| Components | 2-butanone | ethylpyridine | dimethylpyrazine | eugenol | Val | Ile | Leu | Flavor | Taste | Taste |
| Low | 0.00134 | 0.00050 | 0.00054 | 0.00049 | 21.4089 | 17.9559 | 37.6006 | 4.19 | 4.34 | 4.23 |
| Temperature | | | | | | | | | | |
| and Reduced | | | | | | | | | | |
| Pressure | | | | | | | | | | |
| Hot | 0.00167 | 0.00132 | 0.00079 | 0.00055 | 25.7892 | 22.3237 | 47.0948 | 3.44 | 3.58 | 3.68 |
| water | | | | | | | | | | |
| Extraction | | | | | | | | | | |

As shown in Table 1 above, when using the low temperature and reduced pressure extraction method compared to the hot water extraction method, it was confirmed that the off-flavor components, such as 2-butanone, 2-ethylpyridine, 2,6-dimethylpyrazine, and eugenol were reduced, and the bitter taste-related amino acid components, such as Val, lie, and Leu were reduced.

Based on the above results, the effects of reducing the off-flavor and bitter taste of the bonito extract, and increasing the flavor, taste, and umami taste were confirmed by the low temperature and reduced pressure extraction of the present application, thereby confirming that it was suitable for the preparation of bonito extract.

Additionally, the contents of flavor compounds were compared as follows, when using the low temperature and reduced pressure extraction method compared to the hot water extraction method.

TABLE 2

| Relative area (area/total) | | | | |
|---|---|---|---|---|
| GP_low | | | | |
| temperature | | | | |
| and reduced | GY_hot | | | |
| pressure | water | | | |
| extraction | extraction | Compounds | Odor description | CAS No. |
| 0.00134 | 0.00167 | 2-butanone | Artificial odor | 000078-93-3 |
| | | | chemical-like, ethereal, | |
| | | | camphor | |
| 0.00050 | 0.00132 | 2-ethylpyridine | Grassy aroma, | 000100-71-0 |
| | | | roasted-fish, green, | |
| | | | grassy | |
| 0.00054 | 0.00079 | 2,6-dimethylpyrazine | roasted-fish, nuts, beef, | 000108-50-9 |
| | | | coffee | |
| 0.00492 | 0.00568 | n-penatdecane | Bonito smoke flavor | 000629-62-9 |
| 0.00243 | 0.00169 | n-heptadecane | Bonito smoke flavor | 000629-78-7 |
| 0.00977 | 0.00621 | guaiacol | Smoke odor | 000090-05-1 |
| 0.00059 | 0.00000 | 3-Methoxypyridine | roasted-fish | 007295-76-3 |
| 0.00554 | 0.00343 | 2-methylphenol | roasted-fish, artificial | 000095-48-7 |
| | | | odor, phenolic, plastic, | |
| | | | medicinal | |
| 0.00647 | 0.00406 | 3-methylphenol | roasted-fish, artificial | 000108-39-4 |
| | | | odor, medicinal, leather, | |
| | | | phenolic | |
| 0.00049 | 0.00055 | eugenol | Clove, woody, phenolic | 000097-53-0 |

That is, among the above compounds, 2-butanone, 2-ethylpyridine, 2,6-dimethylpyrazine, and eugenol, which were reduced by the low temperature and reduced pressure extraction, are compounds that exhibit grassy, chemical, and woody flavors in addition to the flavor characteristics of katsuobushi, and it was confirmed that these off-flavors were reduced during the low temperature and reduced pressure extraction.

In addition, 2-methylphenol, 3-methylphenol and guaiacol (2-methoxyphenol), which were increased by the low temperature and reduced pressure extraction as phenol compounds, have the description of roasted-fish, a flavor characteristic of katsuobushi, thereby confirming the flavor enhancement effect during the low temperature and reduced pressure extraction.

### Experimental Example 2. Confirmation of Optimal Extraction Temperature for Preparation of Bonito Extract

In order to examine the effect of enhancing the main flavor and umami taste according to temperature conditions when preparing bonito extract using reduced pressure extraction, a comparative experiment was set up with the same reduced pressure conditions and different temperature conditions (30° C., 40° C., 50° C., 60° C.).

The bonito extract was extracted for 60 minutes at different temperatures (30° C., 40° C., 50° C., 60° C.) under the reduced pressure extraction conditions (200 mbar) and filtered, and then, the main flavor and taste components were analyzed.

For the analysis of flavor components, the aroma components of the sample were extracted (solid phase microextraction:SPME), and the compounds were identified through GC-MS (Gas Chromatography-Mass Spectrometry), and confirmed through qualitative analysis.

Additionally, sensory evaluation was conducted on 10 professional researchers.

As a result, as shown in Table 3, it was confirmed that the pattern of the main aroma components (phenol, 2,6-dimethoxy) of the bonito extract extracted at 50° C. was found to be maintained without loss, and that the content of the umami taste-related amino acids (Asp, Glu) as the taste components was increased at temperatures of 50° C. and 60° C.

As a result of the sensory evaluation, it was confirmed that when the bonito extract was extracted at 30° C., the sensory evaluation scores were found to be the lowest, and the flavor components were also not increased.

Additionally, when the bonito extract was extracted at 40° C., sour taste appeared as the result of the sensory evaluation, the bonito extract extracted at 60° C. was found to have a strong flavor but a fishy odor appeared, and the bonito extract extracted at 50° C. was found to be the best in terms of the katsuo flavor and umami flavor, etc.

TABLE 3

| Temperature/ | | | Taste | | Sensory Evaluation Results | | | | |
|---|---|---|---|---|---|---|---|---|---|
| Condition | Flavor Components | | Components | | (5 points) | | | | |
| Main | (ppm) | | (mg/L) | | Katsuo | Katsuo | Umami | Bitter | |
| Component | Phenol | 2,6-dimethoxy | Asp | Glu | Flavor | Taste | Taste | Taste | Neot |
| 30° C. | 8524.95 | 1021.12 | 28.6217 | 37.3083 | 1.85 | 2.11 | 1.58 | 4.34 | |
| 40° C. | 19265.16 | 1374.54 | 28.8617 | 38.6673 | 3.44 | 3.58 | 3.68 | 4.11 | Sour |
| | | | | | | | | | Taste |
| 50° C. | 18256.45 | 1458.65 | 31.826 | 42.4116 | 4.19 | 4.34 | 4.23 | 3.74 | |
| 60° C. | 7259.28 | — | 23.3421 | 32.9173 | 4.33 | 4.42 | 4.12 | 2.56 | Fish |
| | | | | | | | | | Odor |

As a result of the above, it was confirmed that the umami taste of the bonito extract was increased while maintaining the flavor components at a temperature of 50° C. under reduced pressure and low temperature, and the sensory evaluation results also showed excellent sensory characteristics.

### Experimental Example 3. Confirmation of Optimal Time Conditions for Preparation of Bonito Extract

In order to examine the effect of enhancing main flavors and reducing bitterness according to time conditions when preparing bonito extract by reduced pressure extraction, a comparative experiment was set up to compare the effects of each extraction time (30 minutes, 40 minutes, 60 minutes) under reduced pressure and low temperature conditions (200 mbar, 50° C.).

The bonito extract was extracted at reduced pressure (200 mbar) and extraction temperature of 50° C. for 30 minutes, 40 minutes, and 60 minutes, and filtered, and then the taste components and sensory evaluation were analyzed.

As a result, it was confirmed that the bonito extract extracted for 60 minutes had the highest content of umami taste-related amino acids (Asp, Glu), but the bitter taste-related components were also increased. Additionally, when the bonito extract was extracted for 30 minutes, the contents of the taste components were found to be the lowest and the sensory evaluation results were also low.

In contrast, for the bonito extract extracted for 40 minutes, it was confirmed that the off-flavor and umami components were reduced, and the sensory characteristics, such as katsuo flavor, taste, umami taste, etc., were found to be excellent.

TABLE 4

| Extra | | | | | | Sensory Evaluation Results | | | |
|---|---|---|---|---|---|---|---|---|---|
| Condition | | | | | | (5 points) | | | |
| Main | Taste Component (mg/L) | | | | | Katsuo | Katsuo | Umami | Bitter |
| Component | Asp | Glu | Val | Ile | Leu | Flavor | Taste | Taste | Taste |
| 30 minutes | 28.358 | 40.245 | 18.924 | 15.6132 | 32.7181 | 2.81 | 3.35 | 3.46 | 3.96 |
| 40 minutes | 31.826 | 42.4116 | 21.4089 | 17.9559 | 37.6006 | 4.19 | 4.34 | 4.23 | 4.11 |
| 60 minutes | 32.547 | 43.345 | 23.5468 | 20.4034 | 42.946 | 4.32 | 4.12 | 4.15 | 2.56 |

As a result of the above, when the bonito extract was extracted for 40 minutes under reduced pressure and low temperature conditions, the umami taste components were increased, and the sensory evaluation results also showed that the flavor, taste, and umami taste were increased and the bitter taste was reduced, confirming that the above time condition was optimal.

### Example 1-2. Preparation of Tuna Fish Sauce

Natural seasoning ingredients such as kelp extract (1%), ginger extract (0.3%), garlic extract (0.3%), etc. were mixed with the bonito extract (60%) prepared in Example 1-1, and the mixture was sterilized (90° C. for 10 minutes) and processed to prepare tuna fish sauce.

### Experimental Example 4. Confirmation of Optimal Mixing Ratio of Raw Materials When Preparing Tuna Fish Sauce

Tuna fish sauce was prepared by mixing the bonito extract extracted under low temperature and reduced pressure with the seasoning ingredients, followed by sterilization via a processing step.

In order to derive the optimal mixing ratio between the bonito extract and raw materials in the processing step, raw materials such as seasoning ingredients (kelp extract, ginger extract, garlic extract), refined salt, and isomaltooligosaccharide were added according to each content to prepare Preparation Examples 1 to 4, and the sensory characteristics were compared.

TABLE 5

| Tuna Fish Sauce | Preparation | Preparation | Preparation | Preparation |
|---|---|---|---|---|
| (Raw material/Content) | Example 1 | Example 2 | Example 3 | Example 4 |
| Bonito Broth | 55.00 | 60.00 | 61.50 | 65.00 |
| Fermented Extract | 2.00 | 2.00 | 0.50 | 1.00 |
| (TNR) | | | | |
| Yeast Extract | 2.50 | 3.00 | 2.50 | 3.00 |
| Seasoning | | | | |
| Isomaltooligosaccharide | 9.00 | 9.00 | 9.00 | 9.00 |
| Refined Salt | 18.50 | 18.40 | 18.50 | 18.50 |
| Ginger Concentrate | 0.30 | 0.30 | 0.10 | 0.10 |
| Garlic Concentrate | 0.30 | 0.30 | 0.10 | 0.10 |
| Tuna Cooking Liquid | 4.00 | 2.00 | 2.00 | 1.00 |
| Ethanol | 2.00 | 2.00 | 2.00 | 2.00 |
| Apple Extract | 1.00 | 1.00 | 1.00 | 1.00 |
| Kelp Extract | 2.00 | 1.00 | 2.00 | 1.00 |
| Fermented | 0.80 | 1.00 | 0.80 | 0.80 |
| Concentrate | | | | |
| Total | 100 | 100 | 100 | 100 |

Sensory Evaluation (5 points)

| | | | | |
|---|---|---|---|---|
| Overall Taste | 3.8 | 4.5 | 4.1 | 4.1 |
| Katsuo Flavor | 3.6 | 4 | 3.8 | 3.8 |
| Umami Taste | 4.1 | 4.3 | 3.9 | 3.8 |
| Off-smell, | 2.8 | 2.2 | 2.1 | 1.8 |
| Off-flavor (Fish | | | | |
| odor, bitter taste) | | | | |

As shown in Table 5, it was confirmed that among Preparation Examples 1 to 4, Preparation Example 2 had the highest overall sensory evaluation scores, had excellent katsuo flavor and umami taste, and the lowest fishy odor and bitter taste.

From the foregoing, a skilled person in the art to which the present disclosure pertains will be able to understand that the present disclosure may be embodied in other specific forms without modifying the technical concepts or essential characteristics of the present disclosure. In this regard, the exemplary embodiments disclosed herein are only for illustrative purposes and should not be construed as limiting the scope of the present disclosure. On the contrary, the present disclosure is intended to cover not only the exemplary embodiments but also various alternatives, modifications, equivalents, and other embodiments that may be included within the spirit and scope of the present disclosure as defined by the appended claims.

1. A method for preparing a bonito extract, comprising extracting katsuobushi under low temperature and reduced pressure, wherein the extraction under low temperature and reduced pressure is performed for 35 to 50 minutes at a temperature of 45 to 55° C. and a pressure of 150 to 250 mbar.

2. The method of claim 1, wherein the bonito extract has reduced off-flavor and bitter taste and increased flavor and umami taste.

3. A bonito extract, which is prepared by extraction under low temperature and reduced pressure, and has reduced off-flavor and bitter taste and increased flavor and umami taste.

4. The bonito extract of claim 3, comprising phenol or 2,6-dimethoxy, which are flavor components.

5. The bonito extract of claim 4, wherein the phenol among the flavor components is contained in an amount of 10000 to 20000 ppm/L, and the 2,6-dimethoxy is contained in an amount of 1100 to 2000 ppm/L.

6. The bonito extract of claim 3, comprising aspartic acid or glutamic acid, which are umami-tasting amino acids.

7. The bonito extract of claim 6, wherein the aspartic acid is contained in an amount of 24 to 40 mg/L, and the glutamic acid is contained in an amount of 33 to 50 mg/L, which are umami-tasting amino acids.

8. The bonito extract of claim of claim 3, wherein the bonito extract is one in which any one or more selected from 2-butanone, 2-ethylpyridine, 2,6-dimethylpyrazine, and eugenol, which are off-flavor compounds, are reduced.

9. The bonito extract of claim of claim 3, wherein the bonito extract is one in which any one or more selected from valine, isoleucine, and leucine, which are bitter-tasting amino acids, are reduced.

10. A method for preparing a tuna fish sauce with increased flavor and umami taste, comprising: a processing step of mixing and sterilizing the bonito extract prepared by the method of claim 1 and seasoning ingredients.

11. The method of claim 10, wherein the seasoning ingredient is one or more selected from kelp, ginger, and garlic.

12. A tuna fish sauce with increased flavor and umami taste, comprising: a bonito extract extracted under low temperature and reduced pressure; and any one or more selected from kelp, ginger, garlic, refined salt, and oligosaccharides.
